(19) United States
(12) Patent Application Publication
(10) Pub. No.: US 2007/0079234 A1
(43) Pub. Date: Apr. 5, 2007

(54) Modeling XML from binary data

(75) Inventors: Raymond W. McCollum, Redmond, WA (US); Patrick R. Kenny, Dunstable, MA (US)

Correspondence Address: WORKMAN NYDEGGER/MICROSOFT, 1000 EAGLE GATE TOWER, 60 EAST SOUTH TEMPLE, SALT LAKE CITY, UT, 84111, US

(73) Assignee: Microsoft Corporation, Redmond, WA (US)

(21) Appl. No.: 11/241,663

(22) Filed: Sep. 30, 2005

(51) Int. Cl. G06F 17/00; G06F 15/00

(52) U.S. Cl. 715/513

(57) ABSTRACT

The present invention extends to methods, systems, and computer program products for modeling XML from binary data. A rendering module receives a request for an XML document and retrieves binary data corresponding to the requested XML document. The binary data includes at least one data value and a template reference referencing a reusable template. The rendering module accesses the reusable template referenced by the template reference. The reusable template includes fixed portions of XML and at least one replaceable token representing that at least value is to be substituted into the reusable template to replace at least one replaceable token. At least one replaceable token in the template is replaced with a data value from the binary data. The fixed portions of the XML along with the data value from the binary data are rendered as the requested XML document.

### CROSS-REFERENCE TO RELATED APPLICATIONS

Not Applicable.

### BACKGROUND

### 1. Background and Relevant Art

Computer systems and related technology affect many aspects of society. Indeed, the computer system's ability to process information has transformed the way we live and work. Computer systems now commonly perform a host of tasks (e.g., word processing, scheduling, and database management) that prior to the advent of the computer system were performed manually. More recently, computer systems have been coupled to one another and to other electronic devices to form both wired and wireless computer networks over which the computer systems and other electronic devices can transfer electronic data. As a result, many tasks performed at a computer system (e.g., voice communication, accessing electronic mail, controlling home electronics, Web browsing, and printing documents) include the exchange of electronic messages between a number of computer systems and and/or other electronic devices via wired and/or wireless computer networks.

Extensible Markup Language (“XML”) is flexible text format that can be used to exchange data between computer systems. XML allows application developers to create their own customized tags, enabling the definition, transmission, validation, and interpretation of data between applications and between organizations. For example, computer systems connected to the Internet often use XML to communicate.

Even within a single computer system, XML can be used to transfer data between various internal software components. XML is advantageous for the transfer of data because it has its own self-documenting, self-reading format. These properties make XML automatically processable by different software components at a computer system. For example, in an event delivery system, an event publisher can publish an event document in XML format that is turn consumable by an event subscriber without further conversion.

Due at least in part to these interoperability advantageous, software components also often store data at mass storage devices in XML document format. Some software components may store XML documents for later retrieval for their own use. For example, upon start-up, a browser program can retrieve previously stored XML configuration information indicating how the browser program is to operate. Other software components may store XML documents for later retrieval by additional other software components. For example, in an event delivery system, an event publisher can store XML event documents (e.g., in an event log) for later retrieval by event subscribers and/or event viewers.

However, XML is natively inefficient, because XML is based on raw text and because XML has a high degree of redundancy. This results in XML having high space-to-information content ratio. That is, XML is very wordy.

For example, storing a single integer value in XML requires the storage of a relatively large amount supplementing information (e.g., formatting information, data typing information, etc.), in addition to storing the single integer value. Resources used to store this supplemental information are consumed with essentially no benefit to a retrieving software component, since the supplemental information is of no interest to the retrieving software component. That is, the retrieving component is interested primarily in the single integer value.

Thus, storage resources used to store supplemental XML information are at the least underutilized, and may be viewed as wasted. In systems that store increased amounts of XML documents, such as, for example, event delivery systems, underutilized (or wasted) storage resources can be significant.

### BRIEF SUMMARY

The present invention extends to methods, systems, and computer program products for modeling XML from binary data. A rendering module receives a request for an XML document. The rendering module retrieves binary data corresponding to the requested XML document. The binary data includes at least one data value that is to be rendered in the requested XML document and a template reference referencing a reusable template.

The rendering module accesses the reusable template referenced by the template reference. The reusable template includes fixed portions of XML indicative of the shape of the requested XML document and at least one replaceable token. The at least one replaceable token represents that at least value is to be substituted into the reusable template to replace at least one replaceable token.

The rendering module replaces at least one replaceable token in the template with a data value from the binary data. The rendering module renders the fixed portions of the XML along with the data value from the binary data as the XML document, in response to the request for the XML document.

This summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages of the invention will be set forth in the description which follows, and in part will be obvious from the description, or may be learned by the practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates an example computer architecture that facilitates modeling XML from binary data.

FIG. 2 illustrates a flow chart of a method for modeling XML from binary data.

FIG. 3 illustrates an example computer architecture that facilitates modeling events as XML documents based on binary events data.

### DETAILED DESCRIPTION

The present invention extends to methods, systems, and computer program products for modeling XML from binary data. A rendering module receives a request for an XML document. The rendering module retrieves binary data corresponding to the requested XML document. The binary data includes at least one data value that is to be rendered in the requested XML document and a template reference referencing a reusable template.

The rendering module accesses the reusable template referenced by the template reference. The reusable template includes fixed portions of XML indicative of the shape of the requested XML document and at least one replaceable token. The at least one replaceable token represents that at least value is to be substituted into the reusable template to replace at least one replaceable token.

The rendering module replaces at least one replaceable token in the template with a data value from the binary data. The rendering module renders the fixed portions of the XML along with the data value from the binary data as the XML document, in response to the request for the XML document.

Embodiments of the present invention may comprise a special purpose or general-purpose computer including computer hardware, as discussed in greater detail below. Embodiments within the scope of the present invention also include computer-readable media for carrying or having computer-executable instructions or data structures stored thereon. Such computer-readable media can be any available media that can be accessed by a general purpose or special purpose computer. By way of example, and not limitation, computer-readable media can comprise, computer-readable storage media, such as, RAM, ROM, EEPROM, CD-ROM or other optical disk storage, magnetic disk storage or other magnetic storage devices, or any other medium which can be used to store desired program code means in the form of computer-executable instructions or data structures and which can be accessed by a general purpose or special purpose computer.

In this description and in the following claims, a “network” is defined as one or more data links that enable the transport of electronic data between computer systems and/or modules. When information is transferred or provided over a network or another communications connection (either hardwired, wireless, or a combination of hardwired or wireless) to a computer, the computer properly views the connection as a computer-readable medium. Thus, by way of example, and not limitation, computer-readable media can comprise a network or data links which can be used to carry or store desired program code means in the form of computer-executable instructions or data structures and which can be accessed by a general purpose or special purpose computer.

Computer-executable instructions comprise, for example, instructions and data which cause a general purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computer system configurations, including, personal computers, laptop computers, hand-held devices, multi-processor systems, microprocessor-based or programmable consumer electronics, network PCs, minicomputers, mainframe computers, mobile telephones, PDAs, pagers, and the like. The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

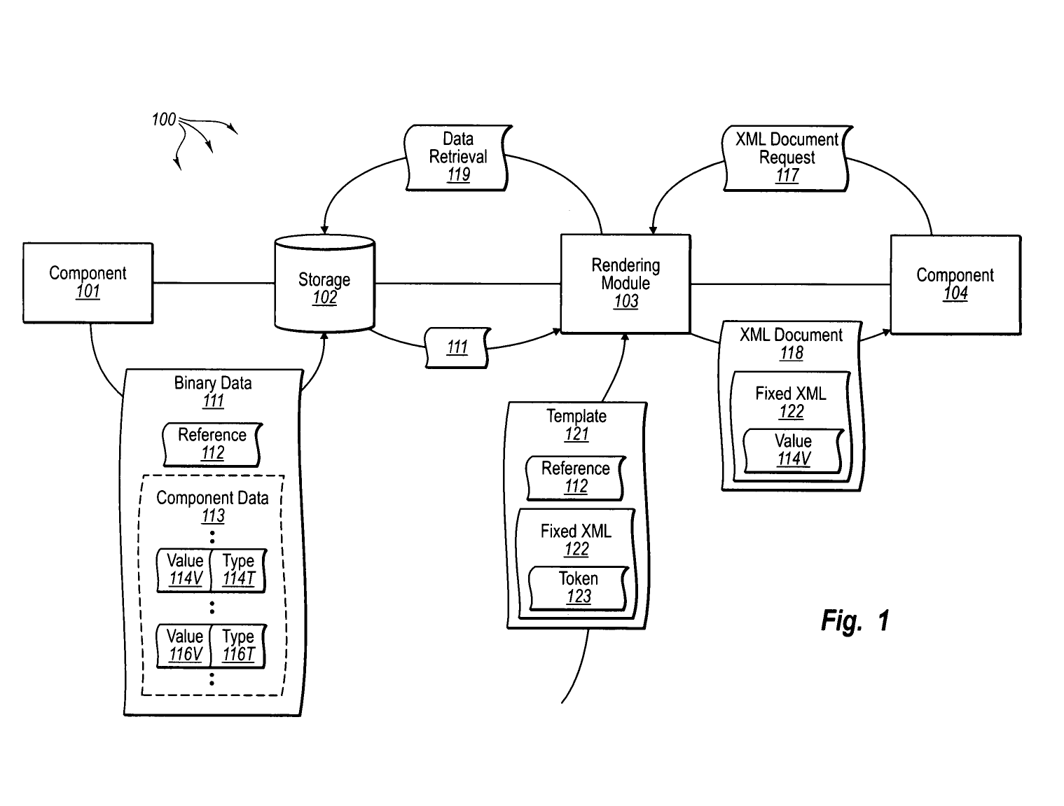

FIG. 1 illustrates an example of a computer architecture 100 that facilitates modeling XML from binary data. In some embodiments, the components of computer architecture 100 are included in a stand alone computer system. Alternately, the components of computer architecture 100 can be included in a distributed computing system with various components at different stand alone computer systems. The components of computer architecture 100 may be connected to internal and/or external peripheral devices, such as, for example, printers, disk drives, scanners, speakers, monitors, etc.

The computer system can be connected to a network, such as, for example, a Local Area Network (“LAN”), a Wide Area Network (“WAN”), or even the Internet. Thus, the computer system and other network connect computer systems can receive data from and send data to other computer systems connected to a network. Accordingly, the computer, as well as other connected computer systems (not shown), can create message related data and exchange message related data (e.g., Internet Protocol (“IP”) datagrams and other higher layer protocols that utilize IP datagrams, such as, Transmission Control Protocol (“TCP”), Hypertext Transfer Protocol (“HTTP”), Simple Mail Transfer Protocol (“SMTP”), etc.) over the network.

Computer system architecture 100 includes component 101, storage 102, rendering module 103, and component 104. Generally, component 101 is configured to generate binary data that is of interest to component 104. The generated binary data can be stored at storage 102 until requested by component 104. Component 104 is configured to request and receive XML documents that include data of interest to component 104. Rendering module 103 is configured to receive requests for XML documents, retrieve relevant binary data from storage 102, identify an appropriate template for rendering the XML document, substitute binary values into the template, and render static portions of the template along with substituted binary values as the requested XML documents.

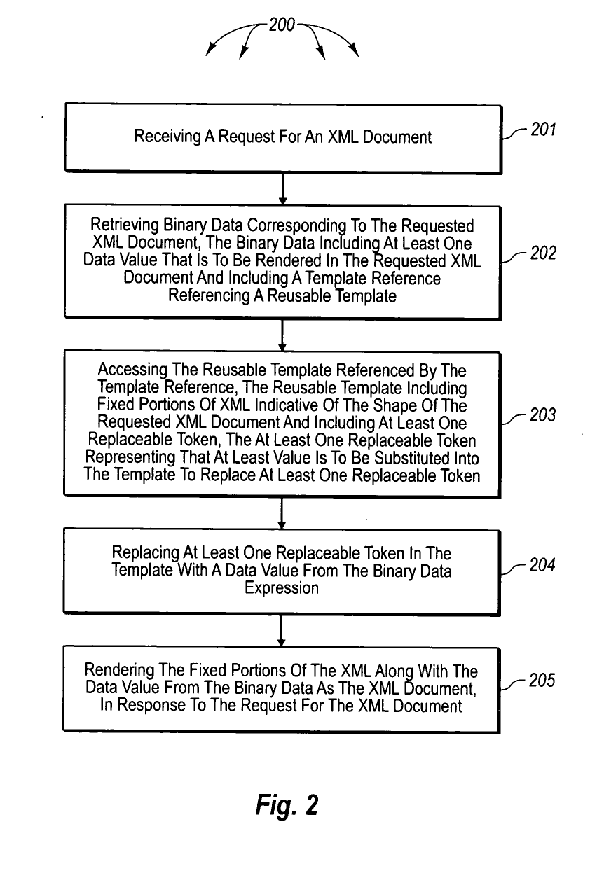

FIG. 2 illustrates a flow chart of a method 200 for modeling XML from binary data. Method 200 will be described with respect to the components and data of computer architecture 100.

Method 200 includes an act of receiving a request for an XML document (act 201). For example, rendering module 103 can receive XML document request 117 from component 104. Rendering module 103 can analyze XML document request 117 to identify a type of XML document that is being requested.

Method 200 includes an act of retrieving binary data corresponding to the requested XML document (act 202). For example, rendering module 103 can perform data retrieval 119 at storage 102 to retrieve binary data 111. Data retrieval 119 can include submitting a data identification data, such as, for example, a filename and constraints on data that is to be retrieved from the file identified by the file name. Binary data 111 can be binary data that was previous generated at component 101 and stored in storage 102.

Retrieved binary data can include at least one data value that is to be rendered in the requested XML document and can include a template reference referencing a reusable template. For example, binary data 111 includes reference 112 and component data 113. Reference 112 can be a reference to template 121. Component data 113 includes a plurality of data values and corresponding data types associated with the data values. For example, component data 113 includes value 114V and type 114T indicating the data type of value 114V. Similarly, component data 113 includes value 116V and type 116T indicating the data type of value 116V.

Method 200 includes an act of accessing the reusable template referenced by the template reference (act 203). For example, rendering module can utilize reference 112 to access template 112. Template 121 may also include reference 112 such that rendering module can match reference 112 from binary data 111 to reverence 112 from template 121.

A reusable template can including fixed portions of XML indicative of the shape of the requested XML document and can include at least one replaceable token. For example, template 121 includes fixed XML 122 and token 123. A replaceable token represents a location within the fixed XML where a binary value is to be substituted into the template to replace the replaceable token. For example, token 123 can represent a location within fixed XML 122 where a binary value from binary data 116 is to replace token 123.

In some embodiments, a template is represented as a prototype XML fragment. The XML fragment contains fixed and constant portions of the XML and special tokens indicating where the unknown values will appear later. An example template can be of the form:

```
<template tid=“T1”>
    <UserData>
      <PrinterConnectionFailure xmlns=“schemas.microsoft.com/
      sample/printerr”>
        <PrinterName>%1</PrinterName>
      </PrinterConnectionFailure>
  </UserData>
</template>
```

In the above example template, the XML desired by the consumer (component 104) is identical to the layout shown, with the exception of the value located where the %1 token is located. Additional substitution points can be defined for additional values using %2, %3, etc. within the body of the template.

Method 200 includes an act of replacing at least one replaceable token in the template with a data value from the binary data (act 204). For example, rendering module 103 can replace token 123 with value 114V. Referring back to the example template above, an actual printer name can be substituted for the %1 token. Thus, the example template can be converted to following example XML:

```
  <UserData>
    <PrinterConnectionFailure xmlns=“schemas.microsoft.com/
    sample/printerr”>
      <PrinterName>PrinterA</PrinterName>
    </PrinterConnectionFailure>
</UserData>
```

To indicate, for example, that PrinterA has had a connection failure.

Method 200 includes an act rendering the fixed portions of the XML along with the data value from the binary data as the XML document, in response to the request for the XML document (act 205). For example, rendering module 103 can present XML document 118 to component 104. As depicted, XML document 118 includes fixed XML 112 form template 121. However, token 123 has been replaced by value 114V. Referring again to the example template and to the example XML above, after an actual printer name is substituted for the %1 token, the XML is in the format requested by the requesting component and can be presented to the requesting component.

In some embodiments, a component may need to supply data types other than simple text strings. Accordingly, a data type system can be established to describe the native binary types used by the computer system and their conversion rules to known XML representations. The component generating the binary data can use these binary types, which are native to its runtime environment, and rendering module 103 can perform the conversion.

An established data type system can include consistent and deterministic transformations from the various data types to a string representation. A string representation can be defined by the computer system, specified in a template and can be known to both the component generating the binary data and the component receiving XML that includes the generated binary data.

For example a rendering module could support the following type mappings:

| Data type | Standard XML format |
|---|---|
| win:AnsiString | xs:string |
| win:UnicodeString | xs:string |
| win:Int8 | xs:byte |
| win:UInt8 | xs:unsignedByte |
| win:Int16 | xs:short |
| win:UInt16 | xs:unsignedShort |
| win:Int32 | xs:int |
| win:UInt32 | xs:unsignedInt |

These types show a mapping of native binary types of an operating system to the equivalent types available in XML Schema 1.0, which can be used to create XML documents. However, other mappings are possible. In these embodiments at runtime, a generating component provides a set of the raw binary values, along with a reference to a template. The requesting component does not have any knowledge of the format of the provided data. The rendering module performs the mapping and rendering process transparently, allowing efficient movement of binary data through the system until XML is actually generated.

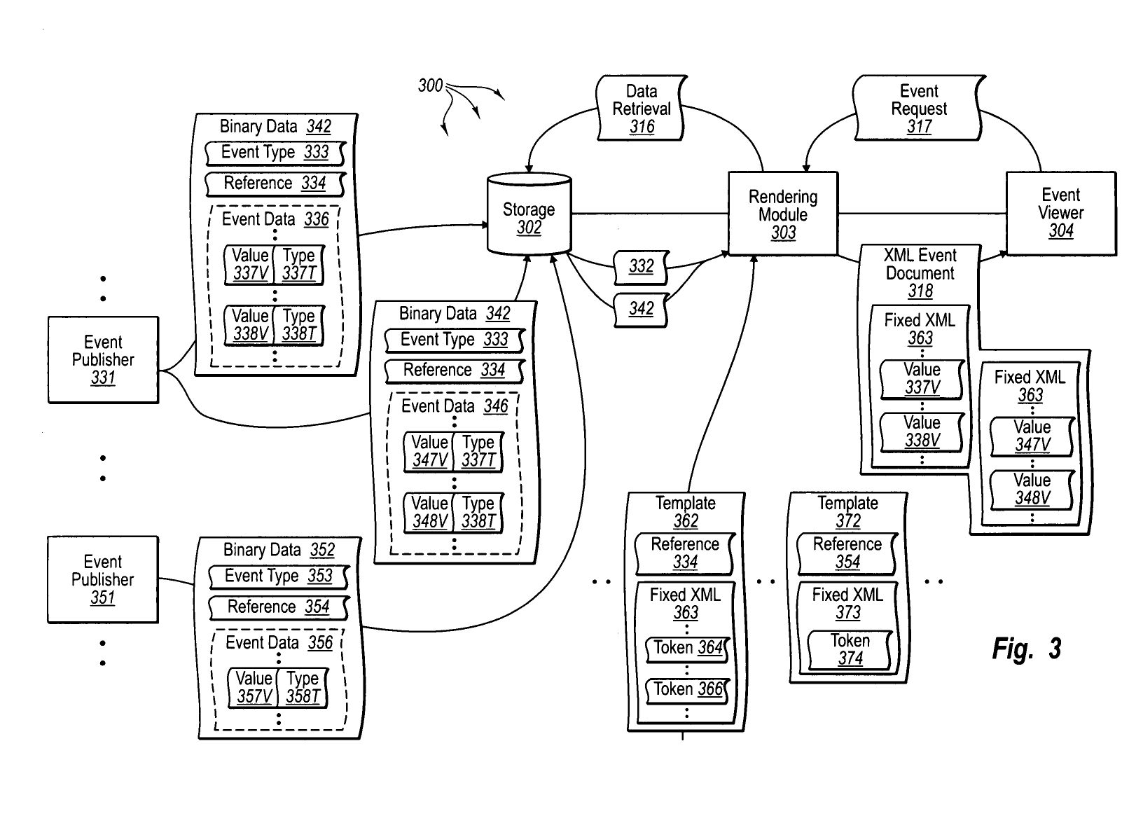

FIG. 3 illustrates a computer architecture 300 that facilitates modeling events XML documents based on binary events data. In some embodiments, the components of computer architecture 300 are included in a computer system (which may or may not be connected to a network). The computer system may be connected to internal and/or external peripheral devices, such as, for example, printers, disk drives, scanners, speakers, monitors, etc.

As depicted, computer architecture 300 includes event publishers 331 and 351, storage 302, rendering module 303, and event viewer 304. A vertical series of two periods (a vertical ellipsis) before event publisher 331, between event publishers 331 and 351, and after event publisher 351, represents that other event publishers may exist before, between, and after event publishers 331 and 351. Generally, event publishers are configured to generate binary data representative of computer system events. The binary data is then stored at storage 302 for later retrieval by other modules (e.g., event subscribers or event viewers) that may be interested in the represented events.

For example, event publisher 331 can publish binary data 332 and 342 representative of an event of event type 333. Similarly, event publisher 351 can publish binary 352 representative of an event of event type 353. Represented events can be virtually any computer system, operating system, computing device, peripheral device, or network related event, such as, for example, printer offline, disk full, network unreachable, system configuration changed, etc.

Binary data for an event can also include a reference to a template and event data including one more value/data type pairs. For example, binary data 332 includes reference 334 and event data 336. Event data 336 further includes value 337V and corresponding data type 337T and value 338V and data type 338T. Likewise, binary data 342 includes reference 334 and event data 346. Event data 346 further includes value 347V and corresponding data type 337T and value 348V and data type 338T. Thus, values 337T and 3347T are of the same data type (type 337T) and values 338V and 348V of the same data type (type 338T).

Similarly, binary data 352 includes reference 354 and event data 356. Event data 356 further includes value 357V and corresponding data type 358T.

Vertical ellipse between the expressly depicted value/data type pairs represent that other value/data type pairs can be included before, between, or after the expressly depicted value/data type pairs within corresponding event data.

Values included in event data can be data relevant to a represented event. For example, event data 336 and 346 can be data relevant to a printer offline event (indicated by event type 333), such as, for example, at least the printer name and Internet Protocol address. Although binary data 332 and 342 indicate the same type of event, the event data can relate to different devices. For example, binary data 332 can represent a printer offline event for a first printer and binary data 342 can represent a printer offline line event for second different printer.

Binary data 352 can indicate a different type of event related to a same or different device. For example, binary data 352 can represent a printer online event for the first printer (with value 357V representing the name of the printer). Alternately, for example, binary data 352 can represent a disk full event at a disk drive (with value 357V representing the ID of the disk drive).

Event viewer 304 is configured to receive event data in XML format and present the event data for viewing. For example, event viewer 304 can send event request 317 (e.g., a request for printer value events) to rendering module 303. Event request 317 can include an event type or other data that can be used to identify an event type.

Rendering module 203 is configured to receive event requests, retrieve relevant binary event data from storage 302, identify an appropriate template for rendering the event data in XML format, substitute binary values into the template, and render static portions of the template along with substituted binary event values as the requested XML documents. For example, rendering module 303 can receive event request 317. In response, rendering module 303 can identify the type of event that is being requested and request relevant binary data from storage 302. For example, rendering module 303 can perform data retrieval 316 at storage 302 to retrieve binary data 332 and 342, for example, printer offline event data. Data retrieval 316 can include submitting a data identification data, such as, for example, a filename and constraints on data that is to be retrieved from the file identified by the file name.

Rendering module 303 may have access to a plurality of different reusable templates for rendering different events in XML format. As depicted, rendering module 303 has access to at least templates 362 and 372. Each template can include a a reference used to identify the template, fixed XML and one or more replaceable tokens. A replaceable token represents a location within the fixed XML where a binary event data is to be substituted into the template to replace the replaceable token. For example, template 372 includes reference 354 and fixed XML 373, which further includes token 374.

Thus, in response to retrieving binary data 332 and 342, rendering module 303 can use reference 334 to identify template 362. Template 362 includes fixed XML 363 indicative of the shape of the requested XML for representing the event and replaceable tokens 364 and 366.

Within template 362, rendering module 103 can replace tokens 364 and 366 with values 337V and 338V respectively within one set of fixed XML 363. Rendering module 103 can then reuse template 362, replacing tokens 364 and 366 with values 347V and 348V respectively within another set of fixed XML 363. Rendering module 303 can then present XML event document 318 to event viewer 304. As depicted, XML event document 318 includes one set of fixed XML 363 containing values 337V and 338V and another set of fixed XML 363 containing values 347V and 348V. Thus, XML event document 318 includes binary event data for two events of the same event type, wherein binary data for each event is included within a common fixed portion of XML that is compatible with event viewer 304 and is responsive to event request 317.

Thus, embodiments of the present invention can be configured to present event data in an XML format even though the event data is stored in a binary format. Binary event data is rendered in an XML document after a request for an XML document. However, a plurality of XML formatted events; each having static XML portions is not stored. Storing in a binary format conserves storage and memory resources used to render events. This in turn increases the efficiency of systems that rendering data in XML, such as, for example, event delivery systems.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. At a computer system, a method for modeling an XML document from binary data such that the binary data can be presented within the XML document and without XML data indicating the shape of the XML document having to be stored with the binary data, the method comprising:
an act of receiving a request for an XML document;
an act of retrieving binary data corresponding to the requested XML document, the binary data including at least one data value that is to be rendered in the requested XML document and including a template reference referencing a reusable template;
an act of accessing the reusable template referenced by the template reference, the reusable template including fixed portions of XML indicative of the shape of the requested XML document and including at least one replaceable token, the at least one replaceable token representing that at least value is to be substituted into the template to replace at least one replaceable token;
an act of replacing at least one replaceable token in the template with a data value from the binary data; and
an act of rendering the fixed portions of the XML along with the data value from the binary data as the XML document, in response to the request for the XML document.

2. The method as recited in claim 1, wherein the act of receiving a request for an XML document comprises an act of receiving a request from a component of the computer system.

3. The method as recited in claim 1, wherein the act of retrieving binary data corresponding to the requested XML document comprises retrieving data that was an act of retrieving binary data created by a component of the computer system.

4. The method as recited in claim 1, wherein the act of accessing the reusable template referenced by the template reference comprises an act of matching the reference included in the binary data to the same reference in the reusable template.

5. The method as recited in claim 1, wherein the act of replacing at least one replaceable token in the template with a data value from the binary data comprises an act of inserting the data value into the fixed portion of XML contained in the template.

6. The method as recited in claim 1, wherein the act of rendering the fixed portions of the XML along with the data value from the binary data as the XML document comprises rendering an XML document in a format requested by a component of the computer system.

7. At a computer system, a method for modeling an XML formatted event document from binary data such that the binary data can be presented within the XML formatted event document without static portions of the XML formatted event document having to be stored with the binary data, the method comprising:
an act of receiving a request for an XML formatted event document representing a computer system event;
an act of retrieving binary event data corresponding to the requested computer system event, the binary event data including at least one data value that is to be rendered in the XML formatted event document and including a template reference referencing a reusable template;
an act of accessing the reusable template referenced by the template reference, the reusable template including fixed portions of XML indicative of the shape of the requested XML formatted event document and including at least one replaceable token, the at least one replaceable token representing that at least value is to be substituted into the template to replace at least one replaceable token;
an act of replacing at least one replaceable token in the template with a data value from the binary event data; and
an act of presenting the fixed portions of the XML along with the data value from the binary data as the XML formatted event document, in response to the request for the event.

8. The method as recited in claim 7, wherein the act of receiving a request for an XML formatted event document representing a computer system event comprises an act of receiving a request from an event viewer.

9. The method as recited in claim 7, wherein the act of receiving a request for an XML formatted event document representing a computer system event comprises an act of receiving a request for a specified type of computer system event.

10. The method as recited in claim 9, wherein the act of receiving a request for a specified type of computer system event comprises an act of receiving a request for an operating system event.

11. The method as recited in claim 7, wherein the act of retrieving binary event data corresponding to the requested computer system event comprises an act of retrieving binary event data that was published by an event publisher at the computer system.

12. The method as recited in claim 7, wherein the act of retrieving binary event data corresponding to the requested computer system event comprises an act of retrieving binary event data related to a plurality of occurrences of the requested computer system event.

13. The method as recited in claim 12, wherein the act of accessing the reusable template referenced by the template reference comprises an act of accessing the reusable template only once.

14. The method as recited in claim 7, wherein the act of accessing the reusable template referenced by the template reference comprises an act of selecting the reusable template from among a plurality of reusable templates based on the template reference.

15. The method as recited in claim 1, wherein the replacing at least one replaceable token in the template with a data value from the binary event data comprises an act of inserting at least data value from the binary event data into the fixed portion of XML.

16. The method as recited in claim 1, wherein the replacing at least one replaceable token in the template with a data value from the binary event data comprises:
an act of inserting at least data value from binary event data related to the first occurrence of the computer system event into a first set of the fixed XML;
an act of inserting at least data value from binary event data related to the second occurrence of the computer system event into a second set of the fixed XML; and
an act of including the first and second sets of fixed XML and corresponding inserted binary values in the XML formatted event document such that a plurality of sets of the fixed XML are rendered even though the template includes a single set of the fixed XML.

17. A computer system, comprising:
one or more processors;
system memory;
one or more computer-readable media having stored thereon computer-executable instructions representing an event delivery system that, when executed by one of the processors, cause the computer system to perform the following:
receive a request for an XML formatted event document representing a computer system event;
retrieve binary event data corresponding to the requested computer system event, the binary event data including at least one data value that is to be rendered in the XML formatted event document and including a template reference referencing a reusable template;
access the reusable template referenced by the template reference, the reusable template including fixed portions of XML indicative of the shape of the requested XML formatted event document and including at least one replaceable token, the at least one replaceable token representing that at least value is to be substituted into the template to replace at least one replaceable token;
replace at least one replaceable token in the template with a data value from the binary event data; and
present the fixed portions of the XML along with the data value from the binary data as the XML formatted event document, in response to the request for the event.

18. The system as recited in claim 17, wherein computer-executable instructions that, when executed, cause the computer system to retrieve binary event data corresponding to the requested computer system event comprise computer-executable instructions that, when executed, cause the computer system to retrieve binary event data that was published by an event publisher at the computer system.

19. The system as recited in claim 17, wherein computer-executable instructions that, when executed, cause the computer system to access the reusable template referenced by the template reference comprise computer-executable instructions that, when executed, cause the computer system to access the reusable template referenced once even though binary event data for multiple occurrences of the requested computer system event were retrieved.

20. The system as recited in claim 17, further comprising computer-executable instructions that, when executed, cause the computer system to:
insert at least data value from binary event data related to the first occurrence of the computer system event into a first set of the fixed XML;
insert at least data value from binary event data related to the second occurrence of the computer system event into a second set of the fixed XML; and
including the first and second sets of fixed XML and corresponding inserted binary values in the XML formatted event document such that a plurality of sets of the fixed XML are rendered even though the referenced reusable template includes a single set of the fixed XML.
